(19) United States
(12) Patent Application Publication
(10) Pub. No.: US 2012/0283974 A1
(43) Pub. Date: Nov. 8, 2012

(54) METHOD, SYSTEM AND APPARATUS FOR LOCATING AND DETECTING INCOHERENT RADIO NOISE TYPICAL OF ILLEGAL PLANT GROW OPERATIONS

(76) Inventors: Robert EARL, Qualicum Beach (CA); Alan MUIR, Victoria (CA)

(21) Appl. No.: 13/464,320

(22) Filed: May 4, 2012

Related U.S. Application Data
(60) Provisional application No. 61/483,341, filed on May 6, 2011.

(51) Int. Cl. G06F 19/00

(52) U.S. Cl. 702/75

(57) ABSTRACT

A method and apparatus for detecting and locating illegal grow operations. The method involves using a radio receiver coupled to more than one antenna to detect a radio frequency signature associated with incoherent radio noise associated with grow lights typical of illegal grow operations. At least one antenna is provided which capable of detecting the presence of high energy radio emissions. At least one antenna is provided with directional sensitivity to pinpoint a source of the high energy radio emissions.

### FIELD OF THE INVENTION

The present invention relates to the detection of illegal grow operations.

### BACKGROUND OF THE INVENTION

Criminal elements go to great lengths to conceal the locations of their illegal grow operations. They place the illegal grow operations in houses in residential neighborhoods or warehouses in industrial parks. There is a need for effective tools that can be used by law enforcement agencies to detect which houses or warehouses may be concealing illegal grow operations.

### SUMMARY OF THE INVENTION

According to one aspect of the present invention there is provided a method for detecting and locating illegal grow operations. The method involves using a radio receiver coupled to more than one antenna to detect a radio frequency signature associated with incoherent radio noise associated with grow lights typical of illegal grow operations. At least one antenna is provided which capable of detecting the presence of high energy radio emissions. At least one antenna is provided with directional sensitivity to pinpoint a source of the high energy radio emissions.

In accordance with this method, one category of antenna is used to determine that there are high energy radio emissions in the vicinity and one or more directionally sensitive antennas are used to pinpoint the source of those high energy radio transmissions. It will be understood that a source can be located using directionally sensitive antennas by known means such as triangulation by using more than one antenna geographically spaced or using a single antenna with readings being taken from at least three locations.

According to another aspect there is provided an apparatus that was developed for use with the method. The apparatus includes a first antenna input including at least one antenna capable of detecting the presence of high energy radio emissions and a second antenna input including at least one antenna with directional sensitivity. A radio receiver is provided capable of receiving 100 KHz to 30 MHz and having amplitude modulation capabilities. A switch is connected to the first antenna input, the second antenna input and the receiver for switching as between the first antenna input and the second antenna input, as antenna input for the receiver. A microprocessor is connected to the receiver and configured for identifying a radio frequency signature associated with incoherent radio noise associated with grow lights typical of illegal grow operations.

There will hereinafter be discussed the technical capabilities and short coming of various types of receivers. Beneficial results may be obtained when the first antenna input includes a vertical antenna. Beneficial results may be obtained when the second antenna input includes a loop antenna.

### SUMMARY OF THE DRAWINGS

FIG. 1, labeled as PRIOR ART, is a schematic representation of an isotropic source, represented as a circle with a diameter of 5/16 wavelength.

FIG. 2, labeled as PRIOR ART, is a schematic representation of a “J-Pole”vertical antenna.

FIG. 3, labeled as PRIOR ART is schematic representations of magnetic loop/coil antennas.

FIG. 4, labeled as PRIOR ART, is schematic representations of a tuned ferrite rod antenna, an equivalent circuit and same at resonance.

FIG. 5 is a schematic representation of an apparatus for detecting and locating incoherent radio noise typical of illegal grow operations.

### DETAILED DESCRIPTION WITH REFERENCE TO THE DRAWINGS

### Technical Background

Electric currents that oscillate at radio frequencies have special properties not shared by direct current or alternating current of lower frequencies. The energy in an RF current can radiate off a conductor into space as electromagnetic waves (radio waves); this is the basis of radio technology

Coherent and Incoherent radio waves—Radio waves are a type of electromagnetic radiation with wavelengths in the electromagnetic spectrum longer then infrared light.

Coherent radio waves are generated when an oscillator is at a predetermined frequency of a specific design. If an oscillator is designed to oscillate at 1 MHz, then the oscillator changes the alternating negative and positive voltage at 1,000,000 times per second. The radio frequency emissions generated by the oscillator are considered to be coherent. By contrast, incoherent radio waves (also known as radio interfering noise or radio hash) are radio waves that cover a broad portion of the radio frequency spectrum.

It has been found that the high-pressure sodium and halide lights associated with marijuana grow operations, emit incoherent radio waves.

In order to receive radio signals an antenna must be used. However, since the antenna will pick up thousands of radio signals at a time, a radio tuner is necessary to tune in to a particular frequency (or frequency range). [1] This is typically done via a resonator—in its simplest form, a circuit with a capacitor and an inductor forming a tuned circuit. The resonator amplifies oscillations within a particular frequency band, while reducing oscillations at other frequencies outside the band.

Antenna—Any piece of conducting material will work as an antenna on any frequency. The aim of any receiving antenna is to convert an electromagnetic wave into a voltage. Even a straightened paper clip will work well. All we have to do is properly match the transmitter or receiver to the paper clip, and the paper clip will receive or radiate ALL of the power fed to it! The aperture of this antenna will have a radius of 5/32 wavelength (0.079 sq. wavelengths cross section area); essentially this is close to the theoretical “Isotropic” source. If this antenna is located in “freespace”, the radiation will be almost equal in all directions. Isotropic is a free space antenna in a hypothetical mathematical environment.

The only reason for building sophisticated antennas is to allow us to control the radiation pattern for a receiver or a transmitter.

The radiation pattern is controlled by focusing the radiated energy. The transmitter radiated pattern is the mirror image of the received pattern. The geometry of the antenna and the proximity of near-by objects are the main controlling factors to have that perfect designed pattern.

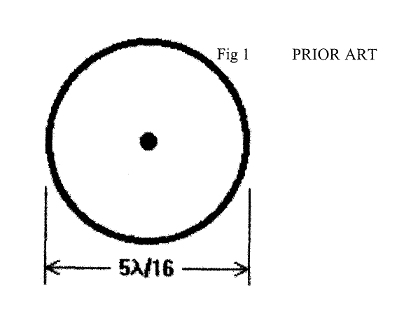

An antenna has an aperture similar to that of a camera lens. The aperture of an isotropic source is a circle with a diameter of 5/16 wavelength, as indicated in FIG. 1.

1. The effects of APERTURE INTERFERENCE—Anything that enters into the aperture of an antenna will affect the operation of the antenna. The effects are pattern distortion, skewing of balance, change of feed impedance and resonant frequency shift; in other words—everything we want to control.

Sometimes it is desirable to cause intentional aperture interference. Placing other conductors into the aperture will cause severe pattern distortion. This can be beneficial when this distortion takes place in such a manner as to focus the radiated energy into a tight beam. This is the basic operating principle of parasitic beam antennas.

2. Ground mounted vertical antennas—One common practice is to mount one half of a dipole (¼ wavelength) vertically on a conducting surface (ground plane). This reduces the size of the aperture by 50%, resulting in a 3 dB loss. As we have seen, a dipole has 2.15 dB gain over an isotropic source; if a ¼ wavelength antenna on a ground plane has 3 dB loss as compared to a dipole, that means that the “¼ wave” antenna has 0.85 dB loss as compared to an isotropic source. Some antenna manufacturers express the gain of their products as “gain over a ¼ wave”. An antenna advertised as having 3 dB gain over a ¼ wave is the same as an antenna having 2.15 dBi gain or 0 dBd gain. It's the same antenna—the bigger numbers are just that—bigger numbers!

A common practice is to mount a vertical antenna on a vehicle. If the antenna is used in the very high frequency, ultra high frequency electromagnetic spectrum, then full size antennas can be used. When the vertically mounted antenna is used in the high frequency electromagnetic spectrum, because of the size of the antenna, then it may be necessary to match the antenna with a device such as an impedance tuner or antenna tuner.

A somewhat less common practice is to mount a vertical dipole directly on the ground. A portion of the aperture is beneath the ground. This induces large currents into the ground surrounding the antenna. With the high (and uncontrollable) ground resistance, these currents result in substantial voltage drops. These losses can be reduced to acceptable levels by installing an extensive ground system (90—½ wavelength long radial wires placed on the ground at 4 degree spacing is about minimum). The severe aperture interference also causes the antenna to exhibit a high angle of radiation. It would be easier (and cheaper) to elevate the antenna far enough so that the aperture does not touch the ground.

3. Elevated vertical antennas—One attempt at elevating a dipole antenna resulted in what is commonly known as the ⅝ wavelength vertical antenna. The theory goes something like this:
“If we elevate a dipole antenna ⅛ wavelength above ground, the aperture will just touch (or just miss) the ground. We can feed the antenna with ⅛ wavelength of high impedance feed line (a single wire should work) and the ground loss and radiation angle problems will disappear.”

Actual construction of these antennas is such that the antenna conductor is continued on down to the ground, where a matching network transforms the high impedance of the ⅛ wavelength long, single conductor, feed line to the low impedance of the line running to the transmitter. The resulting structure is ⅝ wavelength high (hence the common name).

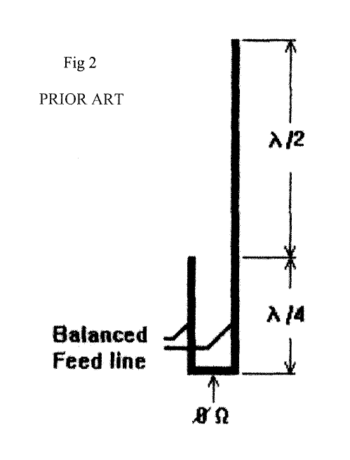

The “J-Pole” vertical antenna. In this design, the antenna is elevated at least ¼ wavelength above ground, thus eliminating the ground losses and “normalizing” the radiation pattern. The Impedance matching between the low impedance feed line and the high impedance of the end of the dipole is accomplished with an open wire stub matching network. A shorting bar is placed at one end of a ¼ wavelength of open wire line, the dipole is then connected to the open end, and the feed line is connected at the point where the impedance of the feed line matches the impedance of the stub. If Co-axial cable feed line is to be used, a BalUn MUST be used. Attempts to feed this antenna directly with co-ax have met with disastrous results. The 0 Ohms reference point is at the center of the short, NOT somewhere up the side of the “J”. A “J-Pole” vertical antenna is represented schematically in FIG. 2.

The advantages of this approach are that it can be fed directly with co-axial cable, a large reduction in wind resistance making it suitable for mobile operation and its total independence from ground. This antenna is easier (and much cheaper) to purchase (mass produced) than it is to build just one!

The PROPER and COMPLETE match—The match between an antenna and its feed line is only proper and complete when the following conditions are met:

a. The antenna impedance is matched to the feed line impedance. The only “right way” to do this is to use a matching network between the feed line and the antenna. ANY adjustments made to the antenna in order to achieve impedance matching will change the radiation pattern of the antenna. There is one notable exception to this: When we want to achieve an impedance transformation, we can insert a short (usually ¼ wavelength long) piece of feed-line that will have a VSWR greater than 1:1.

b. The antenna balance is matched to the feed line balance. When feeding a balanced antenna, a balanced feed line MUST be used. Conversely, when feeding an unbalanced antenna, an unbalanced feed line MUST be used. When it is necessary to mix balances, a balun MUST be used. This can be incorporated into the design of the matching network. A balun is a device that distributes voltage and current equally from unbalanced to balanced feed. The balun can also be used as a transformer to change the impedance from low to high and vice versa.

1:1 VSWR does NOT indicate resonance—The Voltage Standing Wave Ratio (VSWR) is only the ratio between the impedance of the feed line and the load. If we connect a 50 Ohm resistor at one end of a piece of 50 Ohm co-axial cable, and connect a transmitter and SWR meter at the other end, the VSWR will be 1:1. The resistor is NOT, by any means, resonant. If we connect a resonant antenna that has a feed impedance of 272 Ohms to the end of that piece of coax (ignoring any resonance effects of the coax), the VSWR will be 5.44:1. It is possible to cut a piece of feed line to just the right length, and measure a 1:1 VSWR at the transmitter end of that feed line—the actual VSWR on this line is (infinity):!. In this case, the antenna is not resonant. The only practical way to measure the resonant frequency of an antenna is to use a DIP METER at the antenna. High VSWR does NOT cause feed line radiation.

Most transmit and received radiation from coaxial cable is caused by terminating this unbalanced feed line with a balanced load. The remainder of the radiation is due to other problems such as: discontinuities in the outer conductor (braid corrosion is a major factor), improperly installed connectors and signal pickup caused by routing the feed line too close to, and parallel to the antenna.

Contrary to popular belief, properly terminated and installed open wire line does not radiate. Even with infinite SWR, the fields surrounding each wire cancel each other at a distance roughly equal to the wire spacing distance away from the line. Terminating the line in an unbalanced load, or causing anything to come within the “field space” will cause unbalance in the line, thus allowing the line to radiate.

Antenna Gain Information—There are three ways of expressing antenna gain. These are:
dBi Gain over an isotropic source (a theoretical antenna having no dimensions:a geometric point).
dBd Gain over a dipole (0 dBd=2.15 dBi).
dBq Gain over a quarter wavelength whip (bigger numbers than dBi).

The vertical antenna used for detection of high energy emissions is used because of its unity gain and ability to receive in all directions. The average length of a mobile “whip” vertical antenna is 106 inches.

Ferrite antenna—The use of a small Magnetic Loop as an antenna. Although usually better than a Hertzian dipole, the small loop still tends to have a low efficiency due to its low radiation resistance compared to its ‘real’—i.e. dissipation—resistance. One way we can deal with this problem is to try making the loop of a Superconducting material. Although this can work, and indeed is one potentially useful application of ‘high temperature’ superconducting materials, it isn't very convenient in practice due to the need for cooling to low temperatures.

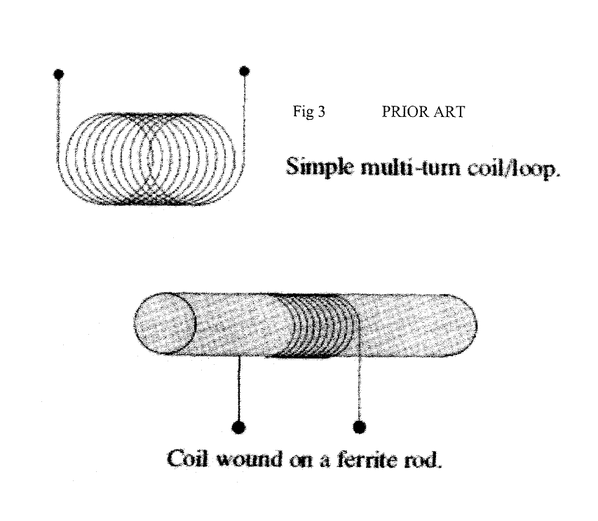

Fortunately, we can also significantly increase the radiation resistance of a loop by placing a suitable piece of Ferrite material inside the loop and modifying it as illustrated in FIG. 3.

The ferrite has the effect of intensifying the magnetic field inside the loop. This effect is produced by the high permeability, μ, of the ferrite material. Usually, it is convenient to use a rod of ferrite material and wind a coil around a central part.

This increases the loop's radiation resistance by a factor of μₑ² to

$${R}_{R} \approx 31200 \times {( \frac{{μ}_{e} n A}{{λ}^{2}} )}^{2}$$

Here μₑ is the ferrite ‘effective’ relative magnetic permeability. This depends upon the choice of material and the size and shape of the rod. (This shape dependence is because some of the magnetic field ‘escapes’ from the rod away from the coil.) For frequencies of a few hundred kilohertz we can obtain ferrite which provide μₑ values in the range from around 100 to around 10,000. Taking the example of an f t, =1,000 we can see that using the ferrite can increase the antenna's radiation resistance by a factor of a million! Hence the ferrite can have a dramatic effect in improving the antenna's efficiency.

Sadly, the usual engineering rule of, “You can't get own for nowt!” (i.e., you can't get anything for nothing) applies. In this case we find that the ferrite itself also tends to absorb some of the signal power. This is caused by the requirement that the alternating magnetic field has to ‘flip’ the magnetic alignment of the magnetic domains inside the granular structure of the ferrite. We can't avoid this as without these domains the material wouldn't be a ferrite and hence would not have a usefully high μₑ value. For a ferrite rod the extra ‘ferrite’ loss has an equivalent resistance,

$${R}_{f} \approx 2 π f {μ}_{e} \frac{{μ}^{′′}}{{μ}^{′}} {μ}_{0} {n}^{2} \frac{{A}_{f}}{{l}_{f}}$$

where μ″ is the imaginary (loss) part, and μ′ the real part of the ferrite's permeability, A_{f} is the cross sectional area of the rod, and l_{f} is the length of the rod. We must now add this to the wire's resistive losses to obtain the overall level of loss resistance in the antenna. Fortunately, by choosing a suitable material we can arrange that this increase in loss can be quite small compared to the increase in R_{R}. Hence, overall, the ferrite significantly improves the antenna's performance.

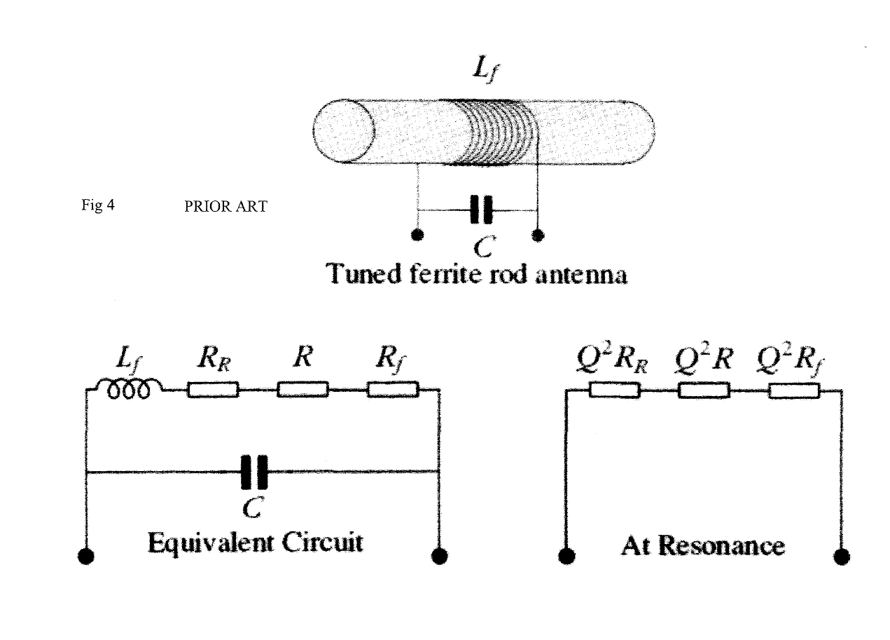

When viewed from the connecting wires, we find that—even when using a high μ ferrite—the antenna's resistance value is often just a few ohms (or even much less than one Ohm) in series with a significant inductance. This combination of a low resistance with a large inductance can make it awkward to match the antenna as a source or load to the receiver or transmitter electronics. To try and deal with this problem it is usual to connect a capacitor to turn the loop into a resonant circuit/antenna as shown in FIG. 4.

Considering FIG. 4, the inductance of this antenna is

$${L}_{f} \approx {μ}_{e} {μ}_{0} {n}^{2} \frac{{A}_{f}}{{l}_{f}}$$

and by using a suitable parallel capacitance, C, we can convert the antenna's terminal impedance, at the resonant frequency

$${f}_{0} \approx \frac{1}{2 π} \sqrt{\frac{1}{{L}_{f} C}}$$

into a pure resistance whose magnitude is Q² larger than the actual loop resistance, where Q is the circuit's Quality Factor,

$$Q ≡ \frac{2 π {f}_{0} {L}_{f}}{R + {R}_{R} + {R}_{f}} = \frac{{f}_{0}}{Δ {f}_{h p}}$$

where Δfₕₚ is the half-power half-bandwidth of the resulting resonance.

For signal frequencies up to a few MHz the Tuned Ferrite Rod antenna can provide antenna efficiencies (and hence gains or effective areas) which can be between a thousand and a million times better than a Hertzian dipole of similar size. For this reason they are often preferred and are used a great deal, for example, in portable radios for the medium wave and long wave bands. The tuned nature of the antenna can sometimes also help filter out unwanted signals at frequencies well away from the required input.

The main disadvantages of the antenna are: the Q may be so high (i.e. fₕₚ so small) that the antenna filters away some of the required signal modulation; the dissipation in the ferrite makes the system unsuitable at a TX antenna; and the uₑ value is only larger than unity for small magnetic field levels.

Losses in the ferrite mean that, if we try using the ferrite in a TX antenna the power dissipated may heat up the material until it decomposes or melts. Since the ferrite behaviour tends to ‘vanish’ (uₑ falls to unity) when we try to apply a large field, we also find that it simply refuses to work as expected when we try to transmit significant power levels. For these reasons the Ferrite Rod makes an excellent RX antenna, but is not used for signal transmission except where the power level to be transmitted is quite low (typically less than a Watt or so).

Summary—You should now see how a variety of different sorts of antenna work. That it is possible to choose a specific gain, operating frequency, etc, by assembling suitable arrays of dipoles. That arrays can contain both driven and passive (or parasitic) elements. That the behaviour of a complex antenna system can be worked out using the principle of field superposition to add together the contributions of all its parts. You should also see how the methods used vary with the size of the antenna compared with the free space wavelength. At low frequencies it should be clear why Tuned Ferrite Rod antennas make excellent RX antennas but are not used for TX antennas.

### DESCRIPTION OF INVENTION

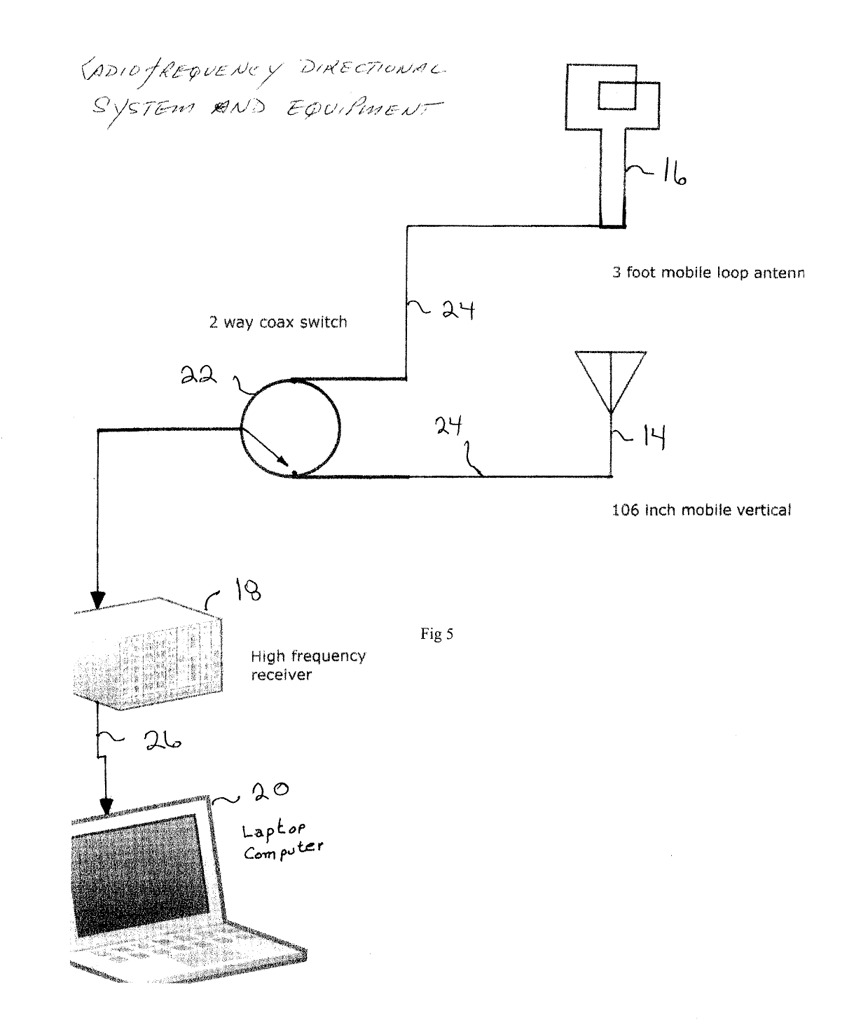

As shown in FIG. 5, a radio directional finding apparatus for the detection of incoherent radio waves, and thus for locating illegal grow operations, has the following components:

1. mobile mounted vertical antenna 2.69 meters long, identified by reference numeral 14;
2. mobile mounted loop antenna 91.44 cm. In diameter, identified by reference numeral 16;
3. high frequency radio receiver that will receive 100 KHz to 30 MHz. This receiver must have amplitude modulation capabilities. (AM), identified by reference numeral 18;
4. dual core 2 GHz laptop computer or better, identified by reference numeral 20;
5. 2 position antenna switch, identified by reference numeral 22;
6. RG-58 coax, identified by reference numeral 24, with connectors (now shown)
7. audio leads, identified by reference numeral 26, with miniature plugs (not shown) to connect computer 20 and receiver 18.

Connections for the radio directional finding apparatus—The vertical mounted antenna is connected by a 50 ohm coax feedline to antenna switch position one. The loop antenna is connected by a 50 ohm coax feedline and is connected to antenna switch position two. The antenna switch output is connected to the receiver's antenna input. The audio frequency receivers output is connected to the computers microphone input.

There are two antennas used for this method. A vertical mounted mobile antenna which will receive radio waves in all directions and a small loop antenna. The small loop antenna is more directional then the vertical and will have a null in the direction of the radio wave source. When the edge of the loop antenna is directed towards the radio frequency source, the null will cause the radio frequency signal to be at a minimum. When the loop is broadside to a radio wave emission, the loop will detect the maximum radio wave signal.

The receiver is preferably a high frequency radio receiver that is designed to receive signals from 100 Khz to 30 MHz and has a sensitivity of 2 micro-volt for a 20 db noise to noise. The frequency to detect radio hash signals associated with marijuana grow operations is in the 1.750 MHz to 4 MHz portion of the radio spectrum. A 6 KHz selective receiver bandwidth is sufficient to receive radio waves from marijuana grow operations for identification. The receiver's mode is to be set to the amplitude modulation mode (AM). The receiver's audio output is connected to the computers laptop microphone input. The audio spectrum analyzer's software will display the signal information when a radio frequency signal is detected.

Radio Frequency Detector device—The detector captures the radio frequencies and changes them to an audio frequency that can be heard by the human ear.

The detector is composed of a radio frequency amplifier to enhance the signal. It incorporates the capturing of electromagnetic or electrostatic signals in the radio frequency portion of the electromagnetic spectrum. The signals are converted to a lower radio frequency, filtered and routed through an audio detector to convert it to an audio stream, amplified and delivered to an acoustic device such as a radio speaker, where it can be heard by the human ear. The modulation is called amplitude modulation.

The circuitry requires electrical power to amplify, convert and operate.

The Radio Frequency Detector can be discrete components, integrated circuit modules, or Software defined receiver components controlled by a computer.

It is desirable that the radio frequency detector be able to function from 1 Megahertz to 4 Megahertz, with a bandwidth of 10 hertz to 6000 hertz over its frequency range. It is desirable that the detector be operational over an environmental temperature range of −25 degrees Celsius to +80 degrees Celsius.

The method for radio detection, analyzing and location by radio directional finding—Driving the radio equipped vehicle into a selected surveillance area, the 2 position antenna switch is switched to position one, that is for the vertical mounted mobile antenna, which is used first for finding a near source of high energy radio emissions.

When a 60 hertz harmonically related signature radio source is detected, the antenna switch is switched to position two, for the loop antenna, for use in determining a more precise location of the source of the radio noise. The source of the incoherent high energy radio emissions can be accurately located by triangulation. The loop antenna is turned left and right so as to identify a signal null (i.e., when the radio signal is at minimum signal strength) so as to obtain a first bearing for the source of the radio noise. Driving to another location close by (20 to 30 meters) and turning the loop antenna again for another null, provides a second bearing.

It is understood that radio directional finding is the only method to locate sources of incoherent high energy radio emissions. When a high energy radio emissions with a harmonically related 60 hertz signature is detected, these type of emissions suggest they are used by high pressure sodium and metal halide lights. These type of lights are known to be used by marijuana grow operations.

The information gathered by this method of detection can be given to authorities for further investigation.

What is claimed is:

1. An apparatus for detecting and locating illegal grow operations, the apparatus comprising:
a first antenna input of at least one antenna capable of detecting the presence of high energy radio emissions;
a second antenna input of at least one antenna with directional sensitivity;
a radio receiver capable of receiving 100 KHz to 30 MHz and having amplitude modulation capabilities
a switch, connected to the first antenna input, the second antenna input and the receiver for switching as between the first antenna input and the second antenna input, as antenna input for the receiver; and
a microprocessor, connected to the receiver and configured for identifying a radio frequency signature associated with incoherent radio noise associated with grow lights typical of illegal grow operations.

2. The Apparatus of claim 1, wherein the first antenna input includes a vertical antenna.

3. The Apparatus of claim 1, wherein the second antenna includes a loop antenna.

4. A method for detecting and locating illegal grow operations, method comprising:
using a radio receiver coupled to more than one antenna to detect a radio frequency signature associated with incoherent radio noise associated with grow lights typical of illegal grow operations;
the more than one antenna comprising:
at least one antenna capable of detecting the presence of high energy radio emissions; and
at least one antenna with directional sensitivity to pinpoint a source of the high energy radio emissions.

5. The method of claim 4, wherein the source of the high energy radio emissions is pinpointed through triangulation by taking readings from at least three locations.
